(19) United States
(12) Patent Application Publication
(10) Pub. No.: US 2009/0074006 A1
(43) Pub. Date: Mar. 19, 2009

(54) METHOD AND APPARATUS FOR PROVIDING A COMMON ACKNOWLEGEMENT CHANNEL

(75) Inventors: Xin Qi, Beijing (CN); Shashikant Maheshwari, Irving, TX (US)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 12/209,317

(22) Filed: Sep. 12, 2008

Related U.S. Application Data
(60) Provisional application No. 60/972,472, filed on Sep. 14, 2007.

(51) Int. Cl. H04J 3/00

(52) U.S. Cl. 370/464

(57) ABSTRACT

An approach is provided for sharing a common acknowledgement channel. A coding and modulation scheme is selected, wherein the coding and modulation scheme utilizes a plurality of sub-carriers associated with a common acknowledgement channel serving a plurality of stations. A plurality of error control-enabled connections is mapped to the common acknowledgement channel by allocating a portion of the sub-carriers to one of the connections and another portion of the sub-carriers to another one of the connections.

### RELATED APPLICATIONS

This application claims the benefit of the earlier filing date under 35 U.S.C. 119(e) of U.S. Provisional Application Ser. No. 60/972,472 filed Sep. 14, 2007, entitled “Method and Apparatus for Providing a Common Acknowledgement Channel,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves acknowledgement signaling. The use of Acknowledgements (ACKs) and/or Negative Acknowledgements (NACKs) are required to indicate whether data has been received successfully, or unsuccessfully. This mechanism is executed by a transmitter and a receiver to notify the transmitter whether the data has to be retransmitted. Such mechanism can introduce unnecessary overhead, degrade system performance, and result in waste of network resources, if not designed properly.

### SOME EXEMPLARY EMBODIMENTS

Therefore, there is a need for an approach for providing an efficient acknowledgement scheme, which can co-exist with already developed standards and protocols.

According to one embodiment of the invention, a method comprises selecting a coding and modulation scheme utilizing a plurality of sub-carriers associated with a common acknowledgement channel serving a plurality of stations. The method also comprises mapping a plurality of error control-enabled connections to the common acknowledgement channel by allocating a portion of the sub-carriers to one of the connections and another portion of the sub-carriers to another one of the connections.

According to another embodiment of the invention, an apparatus comprises coding and modulation logic configured to select a coding and modulation scheme utilizing a plurality of sub-carriers associated with a common acknowledgement channel serving a plurality of stations, and to map a plurality of error control-enabled connections to the common acknowledgement channel by allocating a portion of the sub-carriers to one of the connections and another portion of the sub-carriers to another one of the connections.

According to another embodiment of the invention, a method comprises receiving data over a wireless network, and generating an acknowledgement message in response to receipt of the data. The method also comprises determining channel condition of an acknowledgement channel that is established over the wireless network with one or more stations. In addition, the method comprises selecting, based on the determined channel condition, a coding and modulation scheme among a plurality of coding and modulation schemes associated with the acknowledgement channel for transmission of the acknowledgement message, wherein the acknowledgement channel includes a plurality of error control-enabled connections corresponding to respective groups of sub-carriers. Further, the method comprises transmitting the acknowledgement message over one of the error control-enabled connections using the selected coding and modulation scheme.

According to yet another embodiment of the invention, an apparatus comprises a transceiver configured to receive data over a wireless network. The apparatus also comprises error control logic configured to generate an acknowledgement message in response to receipt of the data. The apparatus further comprises coding and modulation logic configured to determine channel condition of an acknowledgement channel that is established over the wireless network with one or more stations, and to select, based on the determined channel condition, a coding and modulation scheme among a plurality of coding and modulation schemes associated with the acknowledgement channel for transmission of the acknowledgement message. The acknowledgement channel includes a plurality of error control-enabled connections corresponding to respective groups of sub-carriers. The transceiver is further configured to transmit the acknowledgement message over one of the error control-enabled connections using the selected coding and modulation scheme.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing a common acknowledgement (ACK) channel to support multiple error control-enabled connections, according to various exemplary embodiments of the invention;

FIG. 2 is a diagram of a radio communication system capable of providing a common acknowledgement channel, according to various embodiments of the invention;

FIGS. 3A and 3B are flowcharts of processes for mapping multiple error control-enabled connections to a common acknowledgement channel, according to various exemplary embodiments;

FIG. 4 is a flowchart of a process for changing a coding and modulation (CM) scheme to increase performance, according to various exemplary embodiments;

FIG. 5 is a diagram of an exemplary tile to provide a common acknowledgement channel, according to one embodiment;

FIGS. 6A and 6B are diagrams of the coding and modulation scheme for the tile of FIG. 5, according to one embodiment;

FIG. 7 is a diagram of an exemplary tile to provide a common acknowledgement channel by changing the pilot pattern of FIG. 5, according to one embodiment;

FIGS. 8A and 8B are, respectively, a diagram of a “best” coding and modulation (CM) scheme for an exemplary common acknowledgement channel and a diagram of modulation patterns associated with the CM scheme, according to one embodiment;

FIGS. 9A-9H are graphs of simulations of various acknowledgement coding and modulation schemes, according to various embodiments;

FIGS. 10A and 10B are diagrams of an exemplary WiMAX (Worldwide Interoperability for Microwave Access) architecture, in which the system of FIG. 1 can operate, according to various exemplary embodiments of the invention;

FIGS. 11A-11D are diagrams of communication systems having exemplary long-term evolution (LTE) architectures, in which the user equipment (UE) and the base station of FIG. 1 can operate, according to various exemplary embodiments of the invention;

FIG. 12 is a diagram of hardware that can be used to implement an embodiment of the invention; and

FIG. 13 is a diagram of exemplary components of a user terminal configured to operate in the systems of FIGS. 10 and 11, according to an embodiment of the invention.

### DETAILED DESCRIPTION

An apparatus, method, and software for mapping error control-enabled (e.g., hybrid Automatic Repeat Request (ARQ) (HARQ)) connections to a common acknowledgement channel are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with a WiMAX (Worldwide Interoperability for Microwave Access) communication network (e.g., compliant with Institute of Electrical & Electronics Engineers (IEEE) 802.16), a 3GPP LTE or EUTRAN (Enhanced UMTS (Universal Mobile Telecommunications System) Terrestrial Radio Access Network)) architecture, it is recognized by one of ordinary skill in the art that the embodiments of the inventions have applicability to any type of packet based communication system and equivalent functional capabilities.

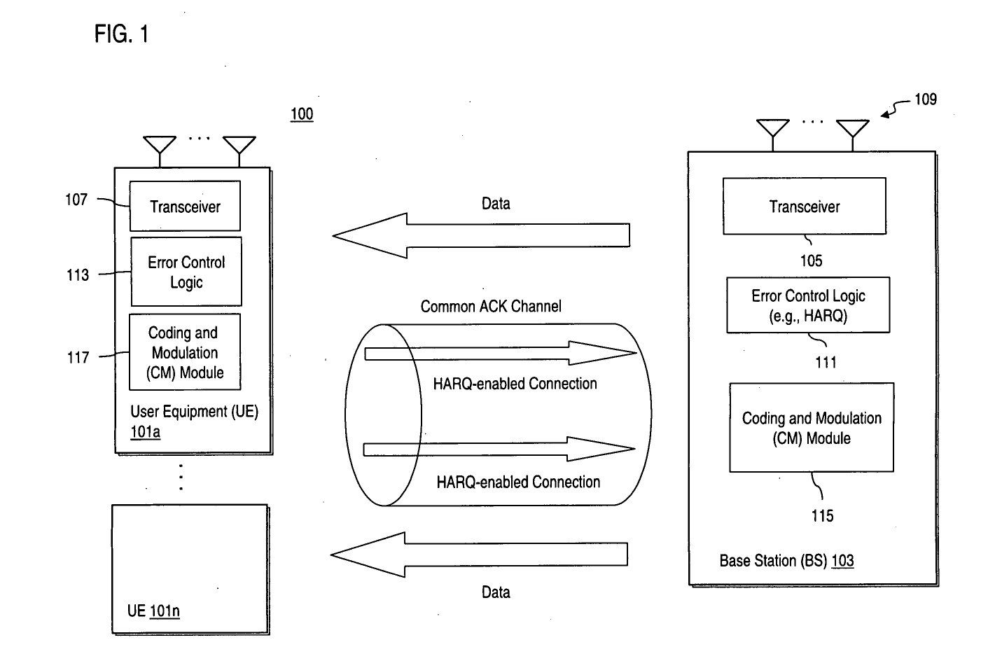

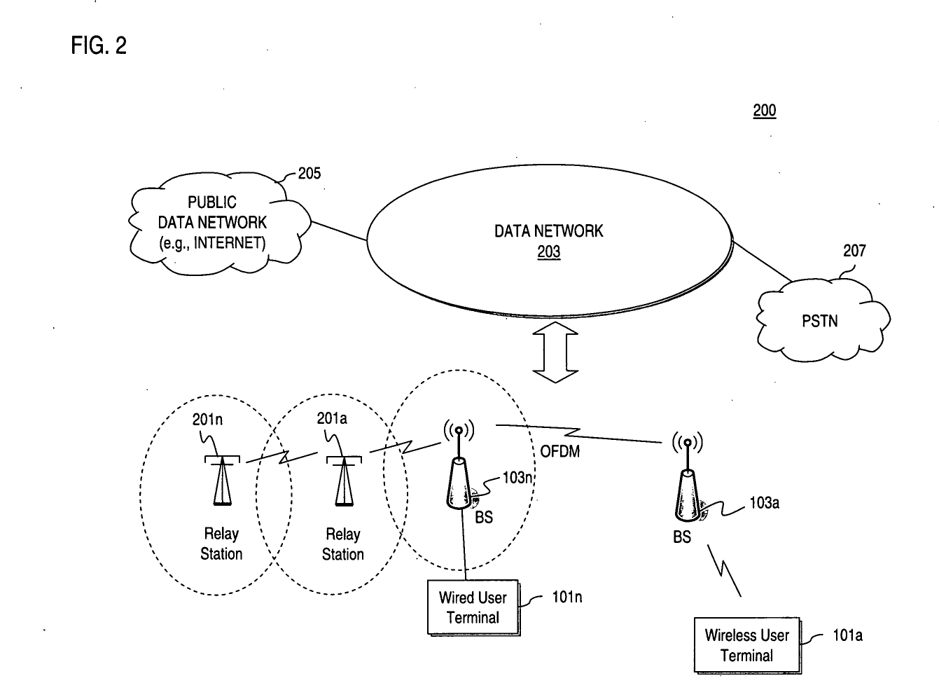

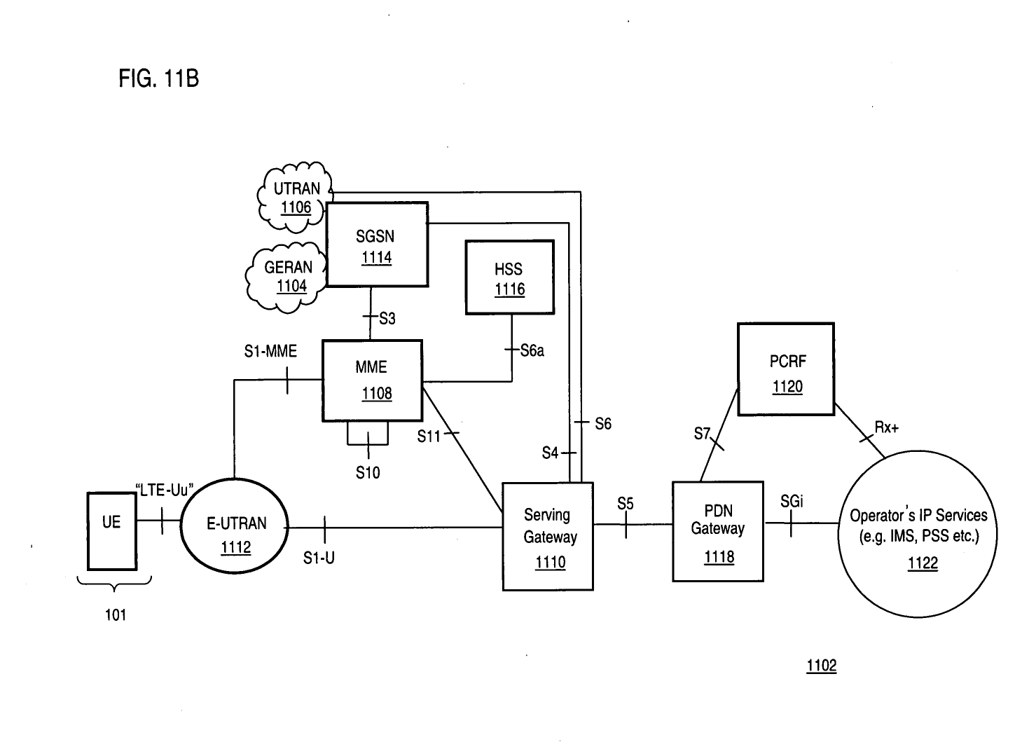

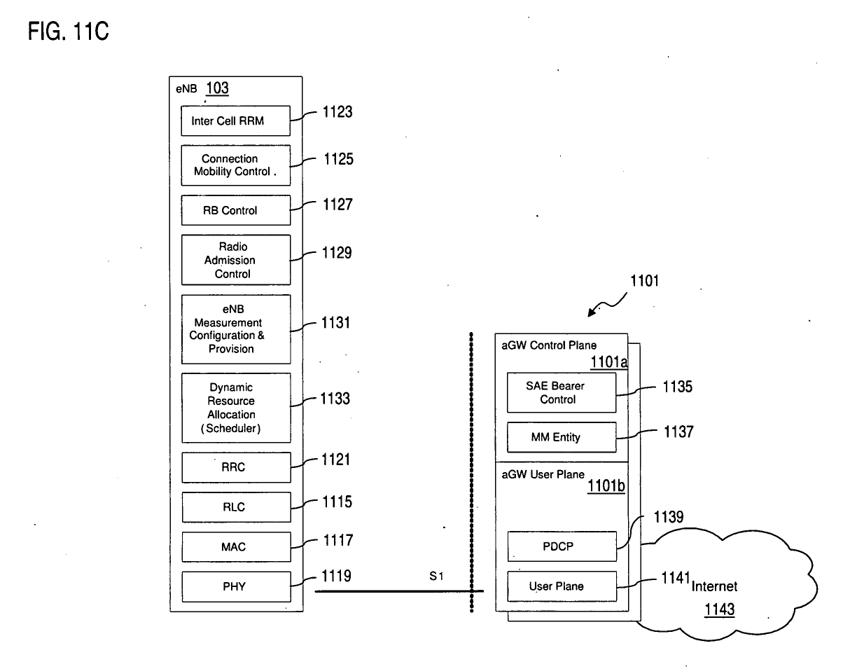

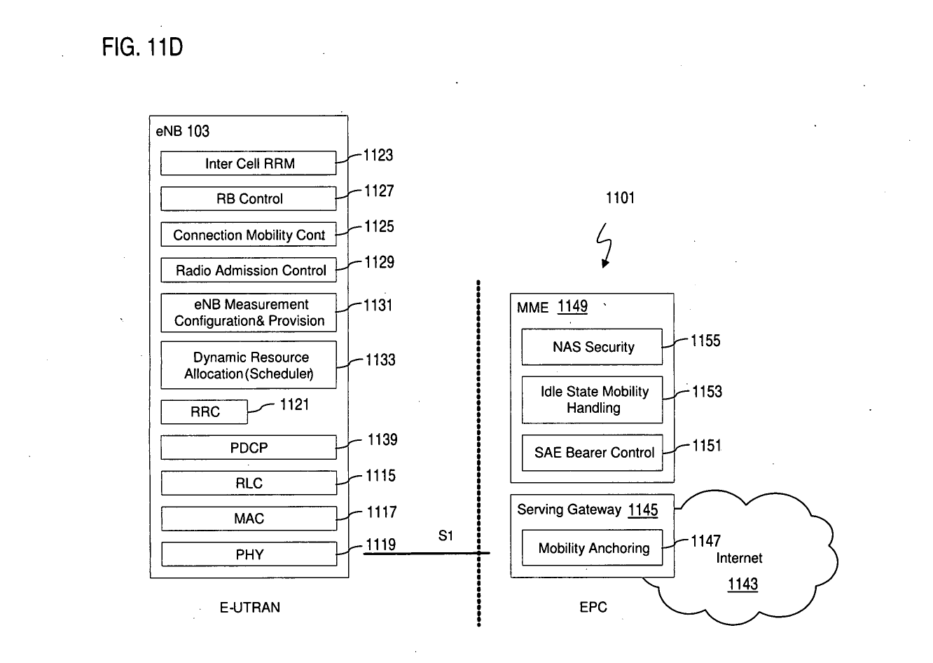

FIG. 1 is a diagram of a communication system capable of providing a common acknowledgement (ACK) channel to support multiple error control-enabled connections, according to various exemplary embodiments of the invention. As shown in FIG. 1, one or more user equipment (UEs) 101a-101n communicate with a base station 103, which is part of an access network (e.g., 3GPP LTE (or E-UTRAN), WiMAX, etc.). For example, under the 3GPP LTE architecture (as shown in FIGS. 11A-11D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants or any type of interface to the user (such as “wearable” circuitry, etc.). The UE 101 can communicate with the base station 103 wirelessly, or through a wired connection. For example, UE 101a wirelessly connects to the base station 103a, while the UE 101n can be a wired terminal, which is linked to the base station 103n. The communication system 100 can extend network coverage through the use of one or more relay nodes (shown in FIG. 2).

In the wireless case, the base station 103a employs a transceiver 105, which transmits information to the UE 101a via one or more antennas 109 for transmitting and receiving electromagnetic signals. The UE 101a, likewise, employs a transceiver 107 to receive such signals. For instance, the base station 103a may utilize a Multiple Input Multiple Output (MIMO) antenna system 109 for supporting the parallel transmission of independent data streams to achieve high data rates between the UE 101a and base station 103a. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

By way of example, the UE 101 and the base station 103 can communicate according to an air interface defined by IEEE 802.16. Details of various IEEE 802.16 protocols are more fully described in the following references, along with additional background materials (which are incorporated herein by reference in their entireties): [1] IEEE 802.16Rev2/D6a, “IEEE draft standard for Local and Metropolitan Area Networks—Part 16: Air interface for fixed Broadband Wireless Access systems”, July 2008; [2] Draft IEEE 802.16m Requirements, [online] http://www.ieee802.org/16/tgm/docs/80216m-07_{—}002r4.pdf; and [3] S. Benedetto and E. Biglieri, Principles of Digital Transmission with Wireless Applications. New York: Kluwer, 1999.

The UE 101 and base station 103 include error control logic 111, 113, respectively, for executing a hybrid Automatic Repeat Request (ARQ) (HARQ) scheme, as well as an acknowledgement signaling logic. Automatic Repeat Request (ARQ) is an error detection mechanism used on the link layer. This mechanism permits a receiver to indicate to the transmitter that a packet or sub-packet has been received incorrectly, and thus, requests the transmitter to resend the particular packet(s). In the system 100, either of the UE 101 or BS 103 can behave as a receiver or transmitter at any particular time.

As seen, the system 100 provides an acknowledgement (ACK) channel that supports multiple HARQ-enabled connections from a single UE or multiple UEs. According to one embodiment, the system 100 utilizes a coding and modulation (CM) method for the ACK channel when UL (Uplink) PUSC (Partial Usage of Sub Channels) is used. The UL ACK/NAK (Negative Acknowledgement) provides feedback for DL (Downlink) HARQ.

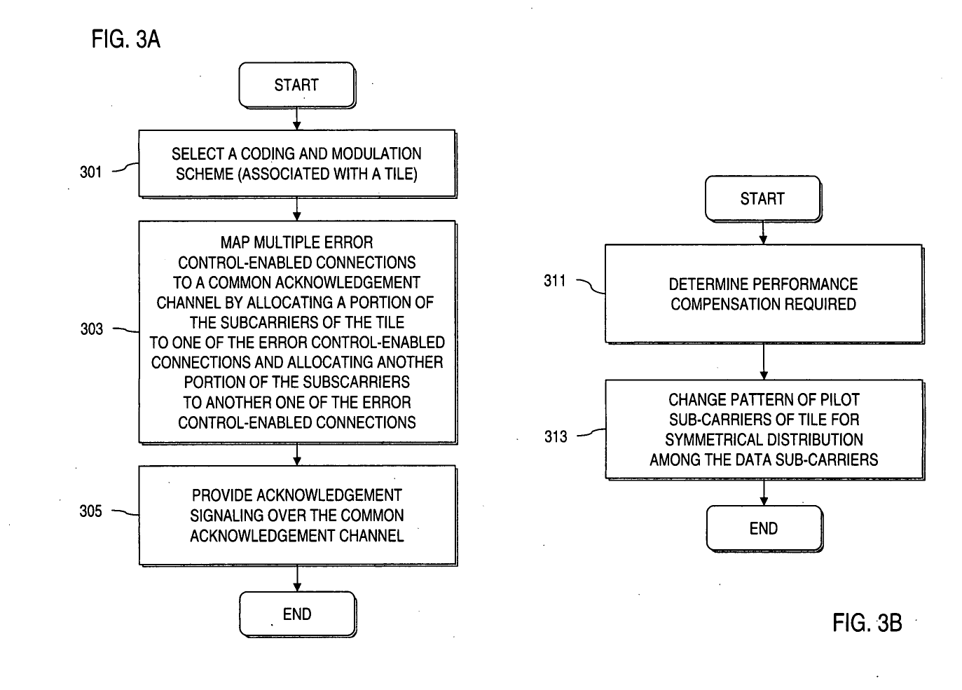

In an exemplary embodiment, two ACK (Acknowledgement) /NAK (Negative Acknowledgement) bits of two HARQ-enabled connections are mapped to a single ACK channel. The ACK channel occupies 3 tiles, as defined in the 802.16 specification (IEEE 802.16Rev2/D6a). As noted, the connections can be associated with different users or the same user. Under this approach, the ACK channel is made more efficient, in terms of PHY (Physical) layer resource consumption. Thus, system throughput is improved. This process is more fully described in FIGS. 3A and 3B.

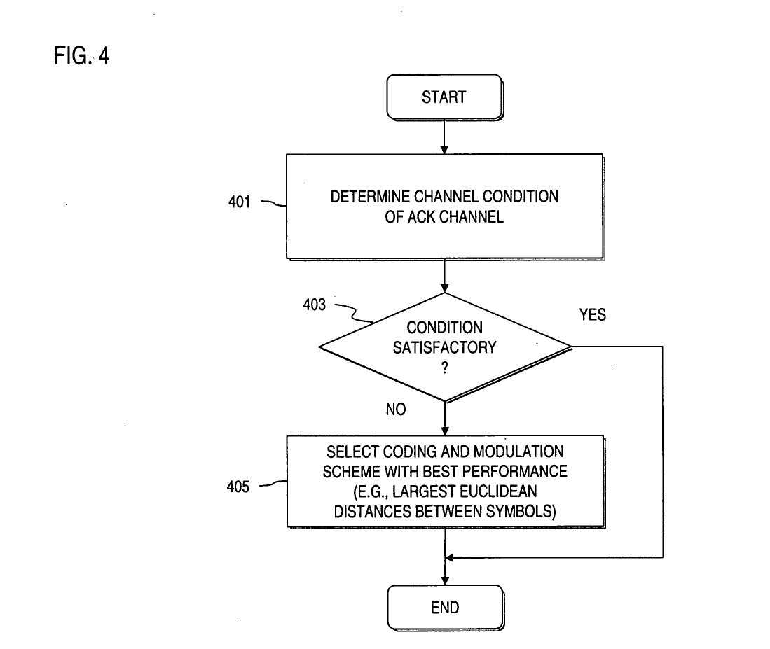

The system of FIG. 1 further provides coding and modulation (CM) for ACK channel with improvement in BER (Bit Error Ratio) performance (as detailed in FIG. 4). This approach provides for improved network coverage through the use of coding and modulation modules 115, 117 within base station 103 and UE 101, respectively.

Although the acknowledgement signaling scheme is described with respect to an UL ACK channel, it is contemplated that such a channel can be used in the DL.

FIG. 2 is a diagram of a radio communication system capable of providing a common acknowledgement channel, according to various embodiments of the invention. For the purposes of illustration, the communication system 200 of FIG. 2 is described with respect to a wireless mesh network (WMN) using WiMAX (Worldwide Interoperability for Microwave Access) technology for fixed and mobile broadband access. WiMAX, similar to that of cellular technology, employs service areas that are divided into cells. As shown, multiple base stations 103a-103n or base transceiver stations (BTSs)—constitute the radio access network (RAN). WiMAX can operate using Line Of Sight (LOS) as well as near/non LOS (NLOS). The radio access network, which comprises the base stations 103 and relay stations 201a-201n, communicates with a data network 203 (e.g., packet switched network), which has connectivity to a public data network 205 (e.g., the global Internet) and a circuit-switched telephony network 207, such as the Public Switched Telephone Network (PSTN).

In an exemplary embodiment, the communication system of FIG. 2 is compliant with IEEE 802.16. The IEEE 802.16 standard provides for fixed wireless broadband Metropolitan Area Networks (MANs), and defines six channel models, from LOS to NLOS, for fixed-wireless systems operating in license-exempt frequencies from 2 GHz to 11 GHz. In an exemplary embodiment, each of the base stations 103 uses a medium access control layer (MAC) to allocate uplink and downlink bandwidth. As shown, Orthogonal Frequency Division Multiplexing (OFDM) is utilized to communicate from one base station to another base station. For example, IEEE 802.16x defines a MAC (media access control) layer that supports multiple physical layer (PHY) specifications. For instance, IEEE 802.16a specifies three PHY options: an OFDM with 256 sub-carriers; OFDMA, with 2048 sub-carriers; and a single carrier option for addressing multipath problems. Additionally, IEEE 802.16a provides for adaptive modulation. For example, IEEE 802.16j specifies a multihop relay network, which can employ one or more relay stations to extend radio coverage.

The service areas of the RAN can extend, for instance, from 31 to 50 miles (e.g., using 2-11 GHz). The RAN can utilize point-to-multipoint or mesh topologies. Under the mobile standard, users can communicate via handsets within about a 50 mile range. Furthermore, the radio access network can support IEEE 802.11 hotspots.

The communication system of FIG. 2 can, according to one embodiment, provide both frequency and time division duplexing (FDD and TDD). It is contemplated that either duplexing scheme can be utilized. With FDD, two channel pairs (one for transmission and one for reception) are used, while TDD employs a single channel for both transmission and reception.

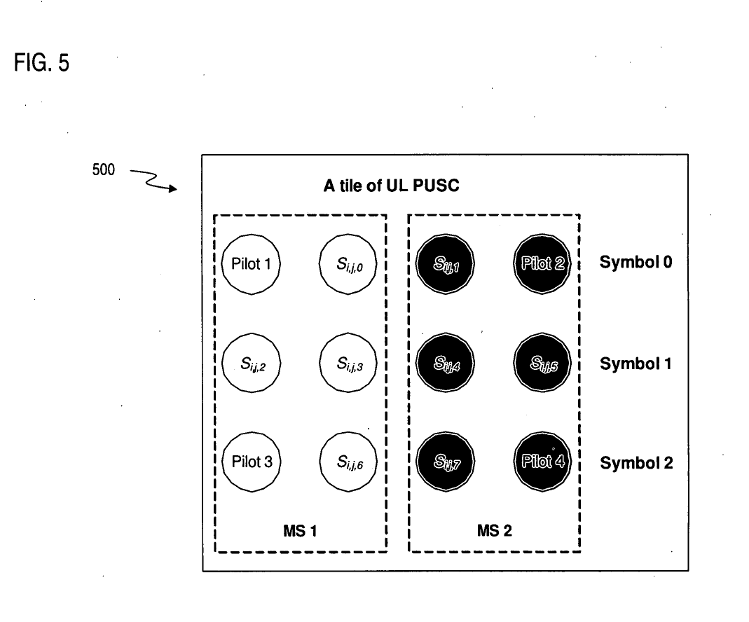

FIGS. 3A and 3B are flowcharts of processes for mapping multiple error control-enabled connections to a common acknowledgement channel, according to various exemplary embodiments. As shown in FIG. 3A, a coding and modulation (CM) scheme is selected, as in step 301. A tile associated with this CM scheme is shown in FIG. 5, for example. The process maps, per step 303, multiple error control-enabled connections to a common ACK channel by allocating a portion of the subcarriers of the tile to one of the connections, and another portion of the subcarriers to another connection. Thereafter, concurrent (or simultaneous) acknowledgement signalling can be performed over the common ACK channel (step 305).

Hence, this approach, in an exemplary embodiment, introduces a CM scheme, whereby ACK/NAK bit from multiple (e.g., two) connections of same or different mobile stations can share a single ACK channel, without performance degradation. This process is described with respect to the tile of FIG. 5. This tile utilizes one set of subcarriers for a first MS (e.g., UE 101a), and another set for a second MS (e.g., UE 101n).

To better appreciate this process, it is instructive to examine conventional approaches to acknowledgement signaling. In the traditional 802.16 ACK CM, each MS has 24 symbols to transmit an ACK/NAK bit. However, the decrease in the number of symbols does not necessarily indicate a degradation in error protection capability. Conventionally, one ACK channel could transmit one Acknowledgment bit, and one ACK channel occupies a half sub channel, which is 3 pieces of 4×3 UL tile in PUSC mode. The Acknowledgment bit of an ACK channel is 0 (ACK) if the corresponding DL packet has been successfully received; otherwise, it is 1 (NAK). This 1 bit is encoded into a length three codeword over 8-ary alphabet for the error protection. Each element of the codeword is further modulated with eight QPSK (Quadrature Phase-Shift Keying) symbols, which are transmitted in the 8 data subcarriers of the tile. This is further explained in IEEE 802.16Rev2/D6a, “IEEE draft standard for Local and Metropolitan Area Networks—Part 16: Air interface for fixed Broadband Wireless Access systems”, July 2008. It is observed that this CM method was originally optimized for fast-feedback channel of 802.16, and then used to define the ACK channel. In fast-feedback channel, 6-bit information is transmitted, while in ACK channel only one bit is transmitted. When the CM was used for ACK channel, it was not optimized accordingly, as evident by the following analysis.

According to classic theory of CM (see S. Benedetto publication), the error-protection performance of a CM could be bounded by averaging the pairwise error probability (PEP) between valid symbol sequences. PEP is determined by SNR (Signal-to-Noise-Ratio) and the distances between the valid symbol sequences of the CM. The meaning of the “distance” is determined by the channel model where the CM is used—e.g., over AWGN (Additive White Gaussian Noise) channel, the performance is determined by the Euclidean distances between valid symbol sequences. Over ideally-interleaved Rayleigh fading channel, the performance is determined by the product of the Euclidean distances between corresponding symbols of the valid symbol sequences. This basic theory can be used to analyze the performance of the UL ACK channel.

The CM of (under the conventional 802.16 approach) ACK channel provides only 2 valid symbol sequences of the CM; these symbol sequences are denoted as x₀ and x₁, corresponding to ACK and NAK, respectively. There are 24 symbols in each valid symbol sequence, which are transmitted in 3 tiles.

xᵢ=t_{i,0},t_{i,1},t_{i,2} (1)

t_{i,j}=s_{i,j,0},s_{i,j,1}, . . . ,s_{i,j,7} (2)

where i=0,1, j=0,1,2, and t_{i,j} is the vector of 8 symbols of a tile, and s_{i,j,k} is a QPSK-modulated symbol, k=0,1, . . . , 7,

$${s}_{i , j , k} ∈ \{ exp ( j \frac{π}{4} ) , exp ( j \frac{3 π}{4} ) , exp ( - j \frac{3 π}{4} ) , exp ( - j \frac{π}{4} ) \} .$$

This yields a parameter dₓ which approximately determines the PEP of the two valid symbol sequences of ACK channel, and therefore determines the performance of the ACK channel.

$$\begin{matrix}{d}_{x} = \sqrt{{\prod }_{j = 0}^{2} {d}_{t , j}^{2}} = \sqrt{{\prod }_{j = 0}^{2} {‖ {t}_{0 , j} - {t}_{1 , j} ‖}^{2}} & ( 3 ) \\ {d}_{t , j} = ‖ {t}_{0 , j} - {t}_{1 , j} ‖ = \sqrt{{\sum }_{k = 0}^{7} {‖ {s}_{0 , j , k} - {s}_{1 , j , k} ‖}^{2}} & ( 4 )\end{matrix}$$

where μs_{0,j,k}−s_{1,j,k}μ² means the square Euclidean distance between symbols s_{0,j,k} and s_{1,j,k}. The larger the value of dₓ, the better the performance. The rationale for obtaining this dₓ is as follows. First, the 3 tiles of the ACK channel are distributed sparsely in the frequency domain, so the channel fading of them could be assumed to be uncorrelated, similar with the assumption of “ideally-interleaved Rayleigh fading channel”. Therefore, dₓ is approximately determined by the product of the “distances” between tiles, d_{t,j}.

Secondly, the 8 subcarriers of a tile are adjacent to each other in frequency and time domain, so the channel fading of them could be assumed to be highly correlated, similar with the assumption of “AWGN channel”. Therefore, “distance” of two valid tiles, d_{t,j}, is the aggregation of Euclidean distances between the symbols of the tiles.

Based on the above analysis, the following conclusion can be drawn. The CM schemes with the same values of d_{t,0}, d_{t,1} and d_{t,2} have very similar performance. To optimize the ACK channel performance is to enlarge the distances of d_{t,0}, d_{t,1} and d_{t,2}. By simple computation using the CM of ACK channel defined in the current standard, it is realized that all values of d_{t,0}, d_{t,1} and d_{t,2} equal to 4.0. However, these are not the best possible values; in fact, the best values are 4\sqrt{2}.

Given the above observations, two approaches are provided to improve the 802.16 ACK channel: (1) improving the ACK channel's efficiency without performance degradation (shown in FIGS. 3A and 3B); and (2) improving the ACK channel's performance (shown in FIG. 4).

As shown in FIG. 3B, the ACK channel performance can be enhanced by manipulating the pilot sub-carriers. Specifically, the required performance compensation is determined, per step 311. Subsequently, the pattern of the pilot sub-carriers can be changed to achieve symmetrical distribution among the data sub-carriers, as in step 313.

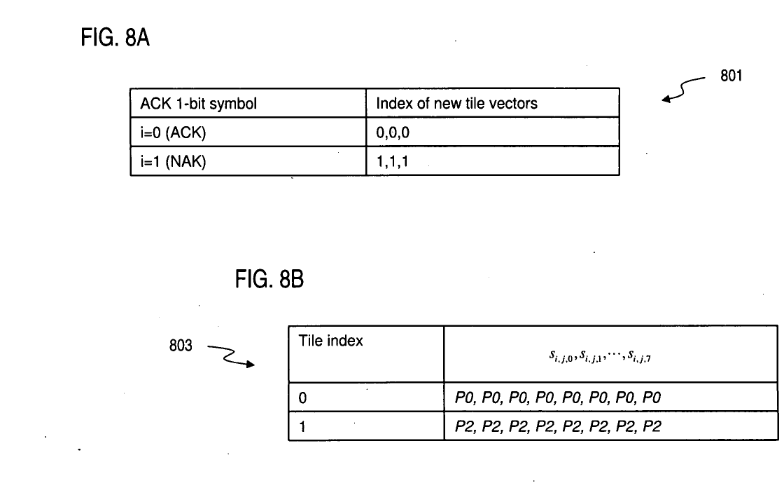

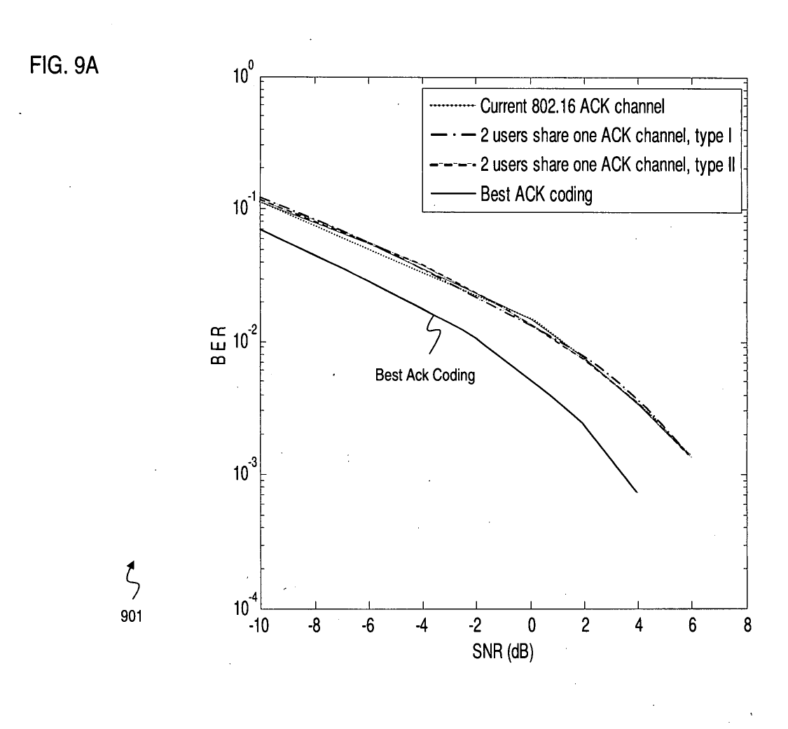

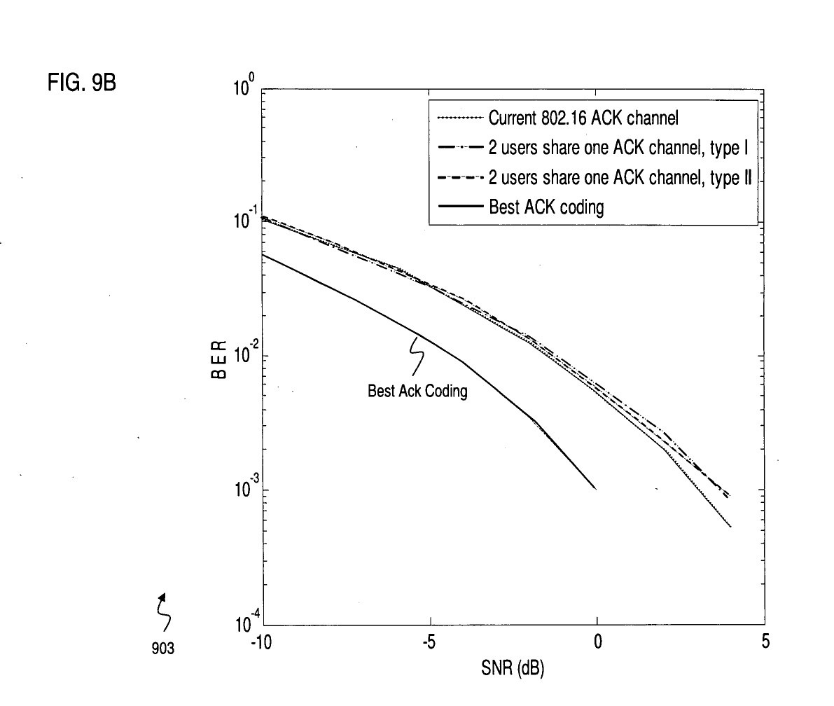

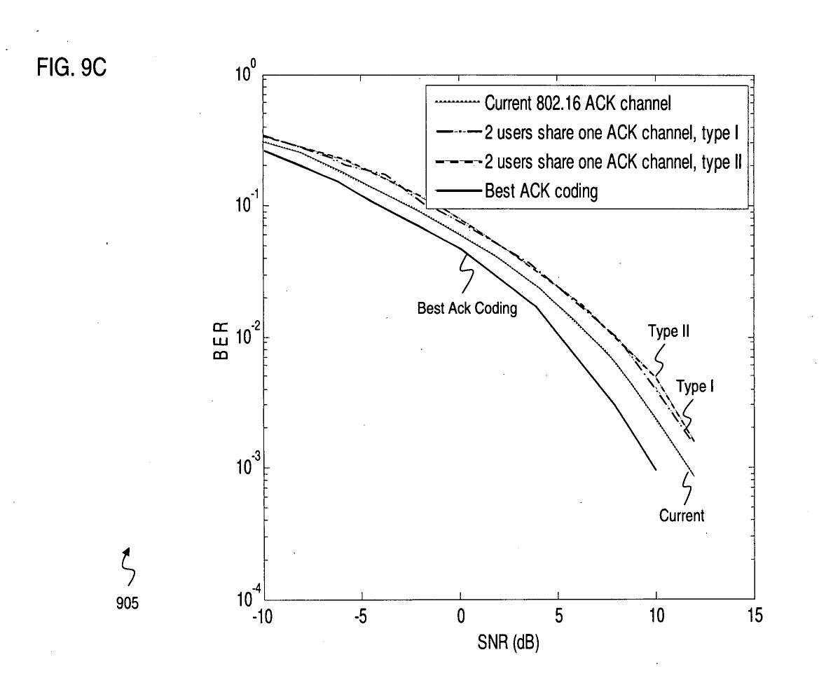

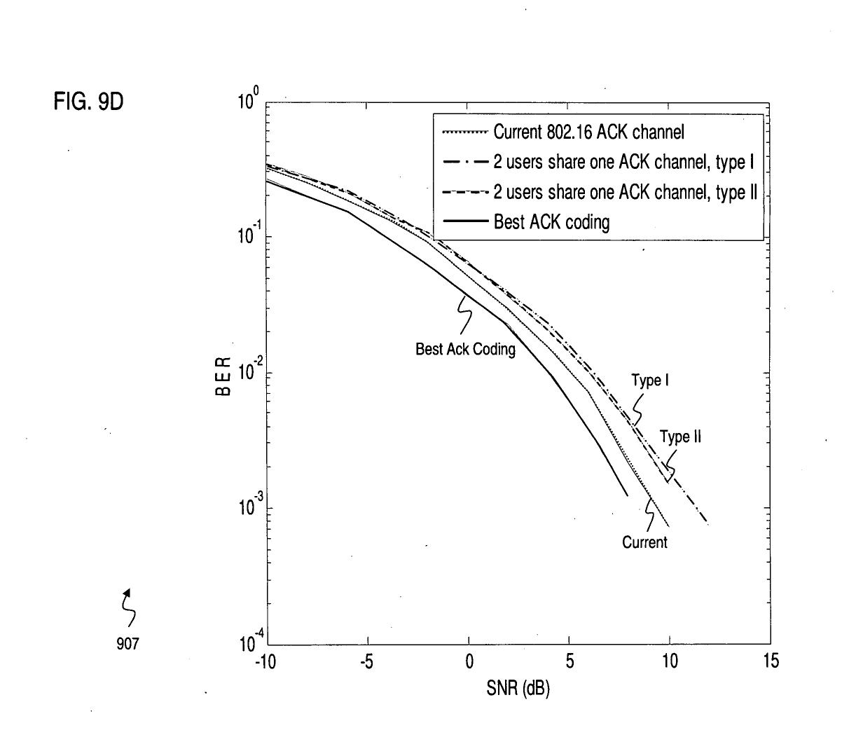

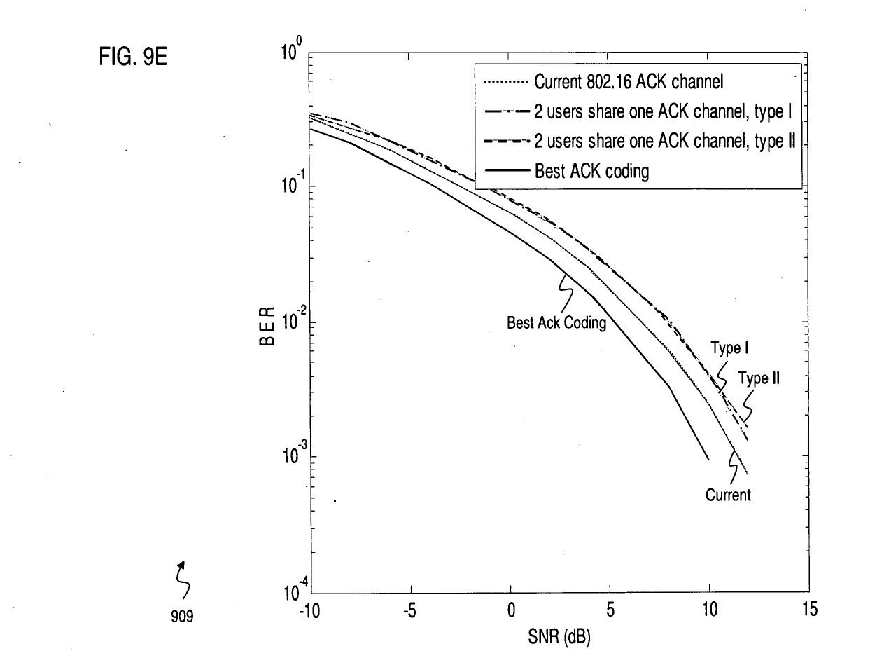

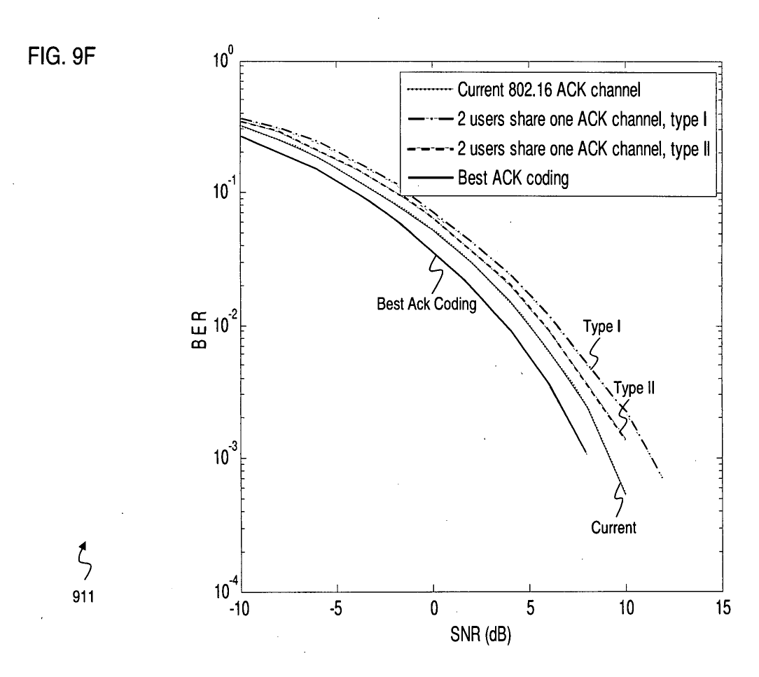

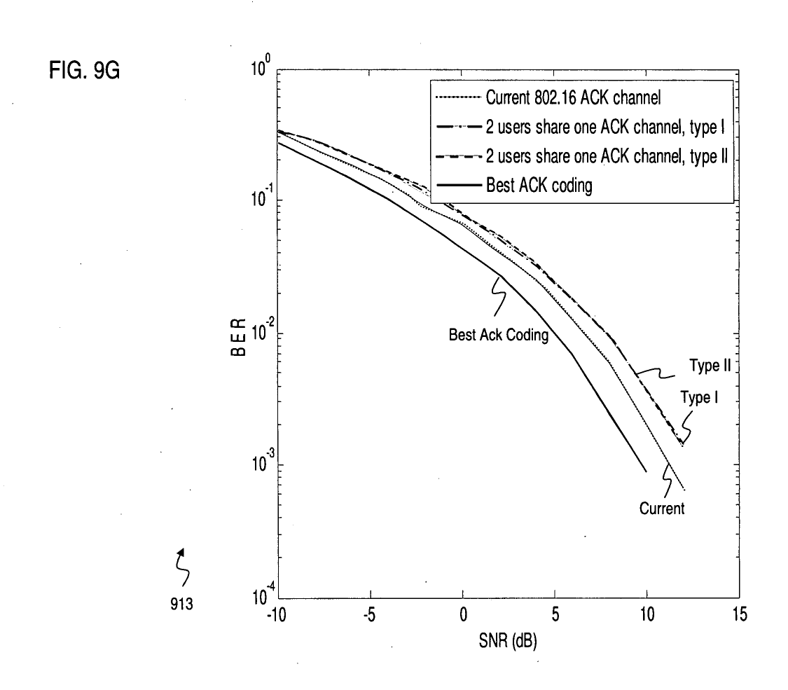

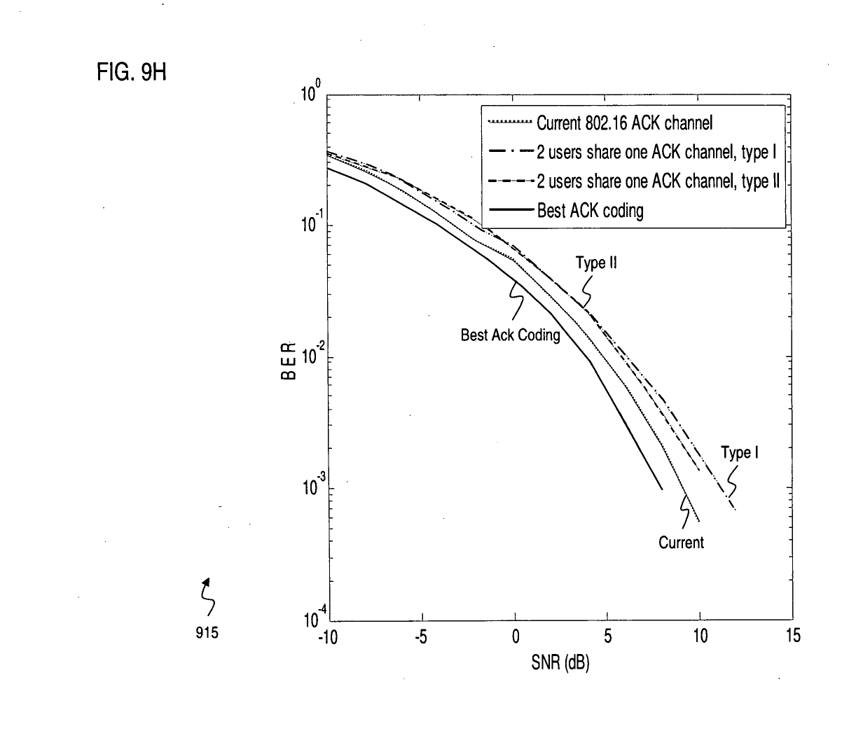

FIG. 4 is a flowchart of a process for changing a coding and modulation (CM) scheme to increase performance, according to various exemplary embodiments. By way of example, in step 401, channel condition of the ACK channel can be determined. If the condition is not satisfactory (step 403), a CM scheme that provides improved or “best” performance can be selected (step 405). The criteria for determining whether such condition is satisfactory can be application dependent. With this process, one ACK channel still contains ACK information from one connection, which is the same efficiency as the current 802.16 scheme. The CM scheme is changed to be the “best” in terms of performance. Table 801 of FIG. 8A provides the definition of the new ACK channel CM scheme, by which, the values of d_{t,0}, d_{t,1}, d_{t,2} are all enlarged to 4\sqrt{2}. The benefit in performance of this new CM is evident from in the simulation results of FIGS. 9A-9H. The new CM is based on a 2-ary alphabet, and the modulation patterns are defined in table 803 of FIG. 8B.

According to certain embodiments, the “best ACK CM” approach provides the following advantages. First, the performance of ACK channels can be improved without any increase in complexity. Therefore, the coverage of UL ACK channel is enhanced. Second, this approach can be implemented in an IEEE 802.16 system, and maintains backward compatibility.

In an exemplary embodiment, the approaches of FIGS. 3A, 3B and 4 can be readily applied to the IEEE 802.16 standard. For example, a two-bit field could be defined to identify which kind of ACK channel CM is used for the connection, including the current 802.16 CM scheme, the CM scheme with the shared ACK channel (type I and type II), and the CM scheme with best performance. This field could be added to any kind of HARQ-DL-MAP-Subburst-IE (information element). It is noted that the “two MSs sharing one ACK channel” approach could be used with UL (Uplink) PUSC mode, while the “best ACK CM” proposal could be used with both UL PUSC and UL optional PUSC mode.

FIG. 5 is a diagram of an exemplary tile to provide a common acknowledgement channel, according to one embodiment. In tile 500, the subcarriers of {Pilot1 Pilot3, s_{i,j,1},s_{i,j,2},s_{i,j,3},s_{i,j,6}} are occupied by MS 1, and other subcarriers are occupied by MS 2. All the 3 tiles of an ACK channel are shared by two MSs in the same way. In this manner, the two MSs (e.g., MS 101a, MS 101n of FIG. 1) are orthogonally mapped to an ACK channel, and each MS's ACK CM has 12 symbols.

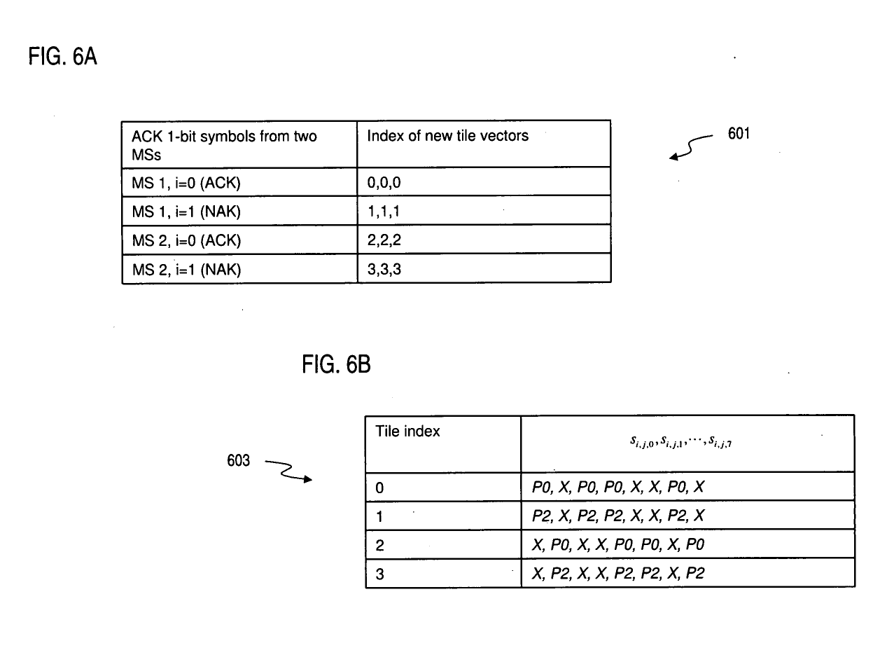

FIGS. 6A and 6B are diagrams of the coding and modulation scheme for the tile of FIG. 5, according to one embodiment. The CM scheme of an ACK channel, in an exemplary embodiment, is defined in table 601 of FIG. 6A. The ACK bit is encoded into a length three codeword over a 4-ary alphabet. Each element of the codeword determines the symbols sequence of the corresponding tile. In an exemplary embodiment, a 4-ary alphabet is utilized, in contrast to a conventional 802.16 ACK channel. The possible modulation patterns of the 4-ary alphabet are defined within table 603 (as seen in FIG. 6B); such patterns ensure that the modulations of the two MSs in one tile are orthogonal in time-frequency domain. Each element in the right column of the table of FIG. 6B corresponds to a 8-symbol sequence—which are the QPSK symbols modulated into s_{i,j,0},s_{i,j,1}, . . . ,s_{i,j,7}.

In the table 603, ‘X’ means that the corresponding subcarrier is not occupied by the MS, and P0˜P3 are of the same definition as current 802.16 ACK channel.

$$P 0 = exp ( j \frac{π}{4} ) \\ P 1 = exp ( j \frac{3 π}{4} ) \\ P 2 = exp ( - j \frac{3 π}{4} ) \\ P 3 = exp ( - j \frac{π}{4} ) \qquad ( 5 )$$

All the values of d_{t,0}, d_{t,1}, d_{t,2} of the two MSs (Mobile Stations) in the exemplary CM scheme are 4, which are the same as the values of the current 802.16 ACK CM. Therefore, the performance of this CM is similar with the traditional 802.16 ACK CM (as evident from the simulation results of FIGS. 9A-9H, when ideal channel estimation is assumed).

Due to the decrease of the pilot subcarriers of each MS from four to two, channel estimation in the new CM could have some degradation compared with the traditional 802.16 scheme. However, based on the simulations of FIGS. 9A-9H, the resulted degradation in ACK channel performance is only 1˜2 dB.

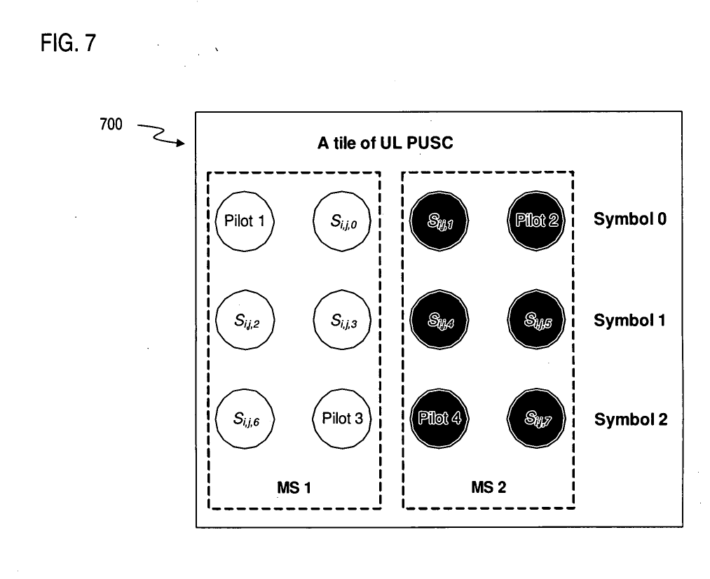

According to another embodiment (as shown in FIG. 3B), the performance degradation due to channel estimation can be compensated for by changing the pattern of pilot subcarriers into that of FIG. 7.

FIG. 7 is a diagram of an exemplary tile to provide a common acknowledgement channel by changing the pilot pattern of FIG. 5, according to one embodiment. Compared to FIG. 5, tile 700 has the positions of pilot 3 and s_{i,j,6} switched. Also, the positions of pilot 4 and s_{i,j,7} are switched. Alternatively, other pilot position switching is also possible, e.g., instead of pilot 3 and pilot 4, pilot 1 and s_{i,j,0} are switched, as well as pilot 2 and s_{i,j,1}. The CM is the same with that in FIG. 6. In this way, the channel estimation accuracy could be improved, largely because the two pilots are more symmetrically distributed in the data subcarriers in the “half tile”.

To distinguish the two pilot patterns, the approach of FIGS. 3A, 5, 6A and 6B is denoted “Type I”, and the approach of FIGS. 3B, 7, 6A and 6B as “Type II”.

According to certain embodiments, the processes of FIGS. 3A and 3B, thus, improve the efficiency of ACK channels by allowing multiple mobile stations, for instance, to share one ACK channel to transmit multiple ACK feedbacks simultaneously. Even with a significant improvement in bandwidth efficiency, the performance in BER is improved in the considered bit error rate (BER) range when the transmission power from a MS per ACK channel is constant. This stems from the fact that when two MSs share one ACK channel, each MS use half of the subcarriers. Thus, the transmission power per subcarrier should be boosted with 3 dB, with the MS transmission power unchanged per ACK channel compared with normal ACK channel in current 802.16. Also, the CM can be easily implemented in an IEEE 802.16 system; and the decoding complexity is not increased. Further, backward compatibility can be preserved.

Moreover, it is noted that even if the performance degradation of the approach of FIGS. 3A and 3B cannot be compensated in certain poor channel conditions when the transmission power per subcarrier is not boosted, the base station could schedule the mobile stations with comparatively good channel condition to use the approach, while the mobile stations with bad channel condition to use the current 802.16 scheme. Under this arrangement, efficiency can still be much improved.

FIGS. 9A-9H are graphs of simulations of various acknowledgement coding and modulation schemes, according to various embodiments. The parameters for the simulations are listed in Table 1.

TABLE 1

| Parameter | Value | |
|---|---|---|
| Frame length | 5 | ms |
| Bandwidth | 10 | MHz |
| RF frequency | 2.5 | GHz |
| Velocity | 30, 60, 150 | km/h |

| | |
|---|---|
| UL permutation | PUSC |
| Channel modeling | Veh-A, Veh-B |

As mentioned, the ACK channel CM, in one embodiment, is simple, having only two valid symbol sequences. Therefore, maximum likelihood (ML) decoding can be readily implemented in this instance. Furthermore, two types of channel estimation are used: ideal and linear interpolation. The signal-to-noise ratio (SNR) for FIGS. 9A-9H represents the signal-to-noise rate per subcarrier. Thus, in all the simulation results of graphs 901-915, the transmission power of the “2 MSs sharing one ACK channel” is not boosted, so that each MS uses half of the transmission power per ACH channel compared with current (or traditional) 802.16 approaches.

The target of the simulation with ideal channel estimation serves to check the performance of CM without considering the influence of channel estimation within a “real world” scenario. Though ideal estimation cannot be realized, it is a good way to prove the performance of CM. Normally, for ACK feedback of HARQ, the BER performance of 10⁻²˜10⁻³ is considered.

Graph 901 of FIG. 9A compares the BER performance of various ACK CM schemes over Veh-A (“vehicle A”) channel with velocity equivalent to 30 km/h. It can be seen that a perfect match between the current 802.16 ACK channel and ACK channel is formed by the processes of FIGS. 3A and 3B, including type I and type II. Also, even though the CM of FIGS. 5, 7, 6A and 6B is twice as efficient in bandwidth consumption, it has the same performance as the CM in the current IEEE 802.16 standard.

The performance of the approach of FIGS. 4, 8A and 8B outperforms the other schemes by 3 dB. This further reveals that with the same efficiency as current 802.16 ACK CM, the performance could be improved much.

In FIG. 9B, graph 903 compares the BER performance of various ACK CM schemes over Veh-B. Results similar to that of graph 901 can be observed, with the only difference being that in high SNR region, the performance of current ACK CM can be slightly better than the processes of FIGS. 3A and 3B, including type I and type II. This can attributed to the fact that Veh-B has much narrower coherent bandwidth than Veh-A channel, so that even within a tile, there is some frequency diversity effect of the current 802.16 CM.

To predict the performance of the CMs in practical scenarios, the simulations are performed with the channel estimation of linear-interpolation executed at the receiver (see FIG. 9C-9H for the results). The simulations have been performed with Veh-A and Veh-B channel, velocity 30 km/h, 60 km/h, and 150 km/h. The same observations are yielded from results that by using the approach of FIGS. 3A and 3B to obtain the twice efficiency over Veh-A channel, with about a˜1 dB performance degradation in the considered BER range. If the channel model changes to Veh-B, the degradation is enlarged to less than 2 dB. This degradation is acceptable considering the large bandwidth efficiency achieved, and could be readily compensated using power boosting. The type II mapping approach can outperform the approach of FIGS. 3A and 3B with type I, especially when Veh-B channel modeling is used and velocity is large. The approach of FIG. 4 can always outperform the current 802.16 CM by 1˜2 dBs.

Because the SNR is the signal-to-noise ratio per subcarrier, if the results were compared based on the same transmitting power, the approach of FIGS. 3A and 3B should have a 3 dB improvement in performance (i.e., a naturally 3 dB power boosting in data and pilot subcarriers). This stems from the fact that the approach uses half the data and pilot subcarriers of an ACK channel, thereby outperforming the current 802.16 ACK CM scheme in the considered BER range.

As mentioned, the described processes may be implemented in any number of radio networks.

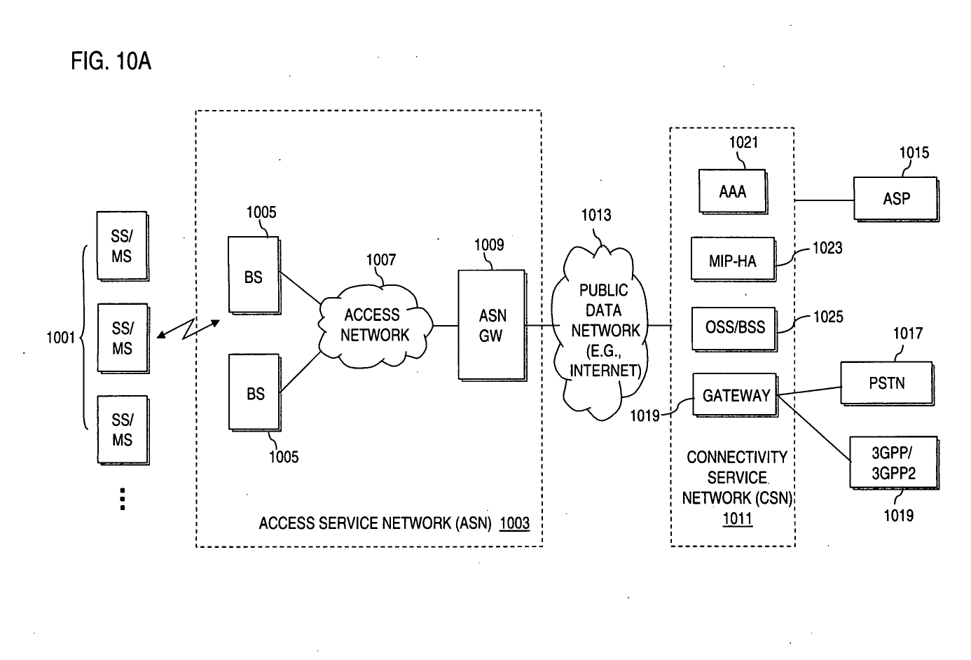

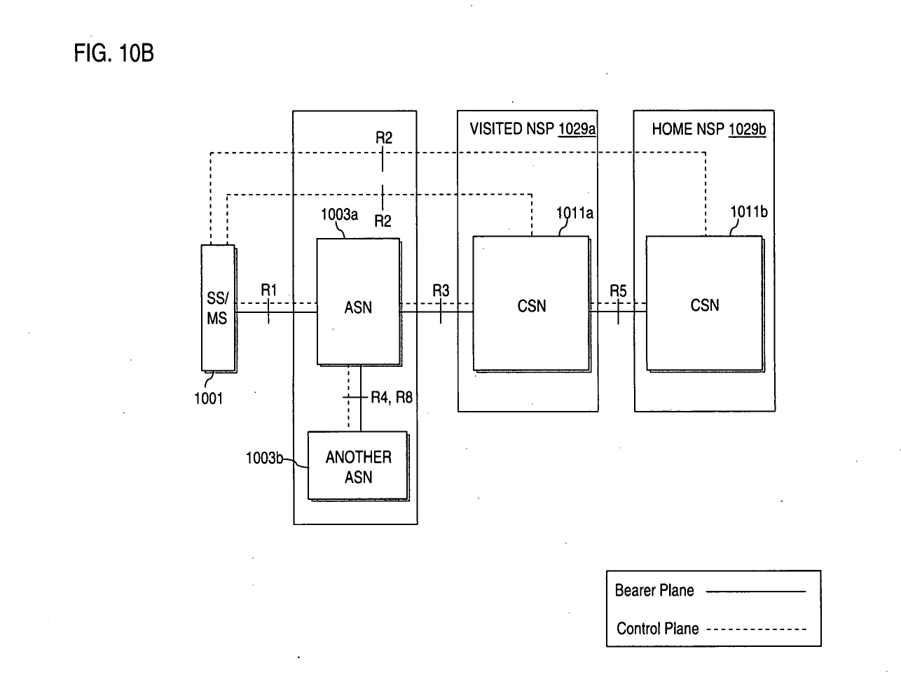

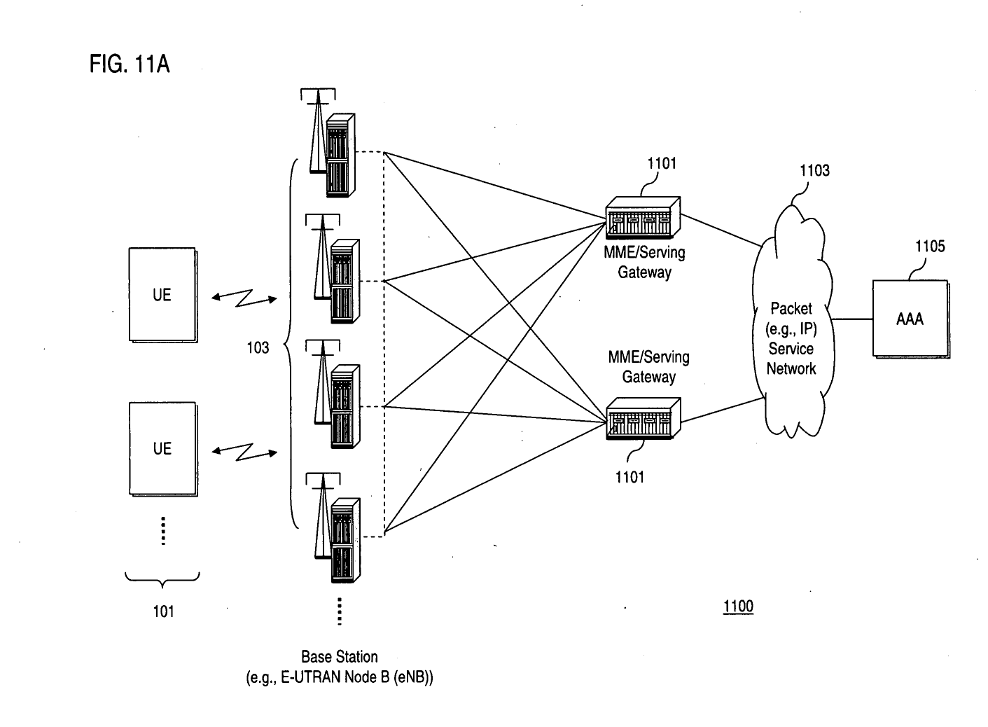

FIGS. 10A and 10B are diagrams of an exemplary WiMAX architecture, in which the system of FIG. 1, according to various exemplary embodiments of the invention. The architecture shown in FIGS. 10A and 10B can support fixed, nomadic, and mobile deployments and be based on an Internet Protocol (IP) service model.

Subscriber or mobile stations 1001 can communicate with an access service network (ASN) 1003, which includes one or more base stations (BS) 1005. In this exemplary system, the BS 1005, in addition to providing the air interface to the mobile stations 1001, possesses such management functions as handoff triggering and tunnel establishment, radio resource management, quality of service (QoS) policy enforcement, traffic classification, DHCP (Dynamic Host Control Protocol) proxy, key management, session management, and multicast group management.

The base station 1005 has connectivity to an access network 1007. The access network 1007 utilizes an ASN gateway 1009 to access a connectivity service network (CSN) 1011 over, for example, a data network 1013. By way of example, the network 1013 can be a public data network, such as the global Internet.

The ASN gateway 1009 provides a Layer 2 traffic aggregation point within the ASN 1003. The ASN gateway 1009 can additionally provide intra-ASN location management and paging, radio resource management and admission control, caching of subscriber profiles and encryption keys, AAA client functionality, establishment and management of mobility tunnel with base stations, QoS and policy enforcement, foreign agent functionality for mobile IP, and routing to the selected CSN 1011.

The CSN 1011 interfaces with various systems, such as application service provider (ASP) 1015, a public switched telephone network (PSTN) 1017, and a Third Generation Partnership Project (3GPP)/3GPP2 system 1019, and enterprise networks (not shown).

The CSN 1011 can include the following components: Access, Authorization and Accounting system (AAA) 1021, a mobile IP-Home Agent (MIP-HA) 1023, an operation support system (OSS)/business support system (BSS) 1025, and a gateway 1027. The AAA system 1021, which can be implemented as one or more servers, provide support authentication for the devices, users, and specific services. The CSN 1011 also provides per user policy management of QoS and security, as well as IP address management, support for roaming between different network service providers (NSPs), location management among ASNs.

FIG. 10B shows a reference architecture that defines interfaces (i.e., reference points) between functional entities capable of supporting various embodiments of the invention. The WiMAX network reference model defines reference points: R1, R2, R3, R4, and R5. R1 is defined between the SS/MS 1001 and the ASN 1003a; this interface, in addition to the air interface, includes protocols in the management plane. R2 is provided between the SS/MS 1001 and a CSN (e.g., CSN 1011a and 1011b) for authentication, service authorization, IP configuration, and mobility management. The ASN 1003a and CSN 1011a communicate over R3, which supports policy enforcement and mobility management.

R4 is defined between ASNs 1003a and 1003b to support inter-ASN mobility. R5 is defined to support roaming across multiple NSPs (e.g., visited NSP 1029a and home NSP 1029b).

As mentioned, other wireless systems can be utilized, such as 3GPP LTE, as next explained.

FIGS. 11A-11D are diagrams of communication systems having exemplary long-term evolution (LTE) architectures, in which the user equipment (UE) and the base station of FIG. 1 can operate, according to various exemplary embodiments of the invention. By way of example (shown in FIG. 11A), a base station (e.g., destination node) and a user equipment (UE) (e.g., source node) can communicate in system 1100 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 1100 is compliant with 3GPP LTE, entitled “Long Term Evolution of the 3GPP Radio Technology” (which is incorporated herein by reference in its entirety). As shown in FIG. 11A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 1101 are connected to the eNBs 103 in a full or partial mesh configuration using tunneling over a packet transport network (e.g., Internet Protocol (IP) network) 1103. Exemplary functions of the MME/Serving GW 1101 include distribution of paging messages to the eNBs 103, termination of U-plane packets for paging reasons, and switching of U-plane for support of UE mobility. Since the GWs 1101 serve as a gateway to external networks, e.g., the Internet or private networks 1103, the GWs 1101 include an Access, Authorization and Accounting system (AAA) 1105 to securely determine the identity and privileges of a user and to track each user's activities. Namely, the MME Serving Gateway 1101 is the key control-node for the LTE access-network and is responsible for idle mode UE tracking and paging procedure including retransmissions. Also, the MME 1101 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 11B, a communication system 1102 supports GERAN (GSM/EDGE radio access) 1104, and UTRAN 1106 based access networks, E-UTRAN 1112 and non-3GPP (not shown) based access networks, and is more fully described in TR 23.882, which is incorporated herein by reference in its entirety. A key feature of this system is the separation of the network entity that performs control-plane functionality (MME 1108) from the network entity that performs bearer-plane functionality (Serving Gateway 1110) with a well defined open interface between them S11. Since E-UTRAN 1112 provides higher bandwidths to enable new services as well as to improve existing ones, separation of MME 1108 from Serving Gateway 1110 implies that Serving Gateway 1110 can be based on a platform optimized for signaling transactions. This scheme enables selection of more cost-effective platforms for, as well as independent scaling of, each of these two elements. Service providers can also select optimized topological locations of Serving Gateways 1110 within the network independent of the locations of MMEs 1108 in order to reduce optimized bandwidth latencies and avoid concentrated points of failure.

As seen in FIG. 11B, the E-UTRAN (e.g., eNB) 1112 interfaces with UE 101 via LTE-Uu. The E-UTRAN 1112 supports LTE air interface and includes functions for radio resource control (RRC) functionality corresponding to the control plane MME 1108. The E-UTRAN 1112 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 1108, as a key control node, is responsible for managing mobility UE identifies and security parameters and paging procedure including retransmissions. The MME 1108 is involved in the bearer activation/deactivation process and is also responsible for choosing Serving Gateway 1110 for the UE 101. MME 1108 functions include Non Access Stratum (NAS) signaling and related security. MME 1108 checks the authorization of the UE 101 to camp on the service provider's Public Land Mobile Network (PLMN) and enforces UE 101 roaming restrictions. The MME 1108 also provides the control plane function for mobility between LTE and 2G/3G access networks with the S3 interface terminating at the MME 1108 from the SGSN (Serving GPRS Support Node) 1114.

The SGSN 1114 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 1108 and HSS (Home Subscriber Server) 1116. The S10 interface between MMEs 1108 provides MME relocation and MME 1108 to MME 1108 information transfer. The Serving Gateway 1110 is the node that terminates the interface towards the E-UTRAN 1112 via S1-U.

The S1-U interface provides a per bearer user plane tunneling between the E-UTRAN 1112 and Serving Gateway 1110. It contains support for path switching during handover between eNBs 103. The S4 interface provides the user plane with related control and mobility support between SGSN 1114 and the 3GPP Anchor function of Serving Gateway 1110.

The S12 is an interface between UTRAN 1106 and Serving Gateway 1110. Packet Data Network (PDN) Gateway 1118 provides connectivity to the UE 101 to external packet data networks by being the point of exit and entry of traffic for the UE 101. The PDN Gateway 1118 performs policy enforcement, packet filtering for each user, charging support, lawful interception and packet screening. Another role of the PDN Gateway 1118 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 1120 to Policy and Charging Enforcement Function (PCEF) in the PDN Gateway 1118. The SGi interface is the interface between the PDN Gateway and the operator's IP services including packet data network 1122. Packet data network 1122 may be an operator external public or private packet data network or an intra operator packet data network, e.g., for provision of IMS (IP Multimedia Subsystem) services. Rx+is the interface between the PCRF and the packet data network 1122.

As seen in FIG. 11C, the eNB 103 utilizes an E-UTRA (Evolved Universal Terrestrial Radio Access) (user plane, e.g., RLC (Radio Link Control) 1115, MAC (Media Access Control) 1117, and PHY (Physical) 1119, as well as a control plane (e.g., RRC 1121)). The eNB 103 also includes the following functions: Inter Cell RRM (Radio Resource Management) 1123, Connection Mobility Control 1125, RB (Radio Bearer) Control 1127, Radio Admission Control 1129, eNB Measurement Configuration and Provision 1131, and Dynamic Resource Allocation (Scheduler) 1133.

The eNB 103 communicates with the aGW 1101 (Access Gateway) via an S1 interface. The aGW 1101 includes a User Plane 1101a and a Control plane 1101b. The control plane 1101b provides the following components: SAE (System Architecture Evolution) Bearer Control 1135 and MM (Mobile Management) Entity 1137. The user plane 1101b includes a PDCP (Packet Data Convergence Protocol) 1139 and a user plane functions 1141. It is noted that the functionality of the aGW 1101 can also be provided by a combination of a serving gateway (SGW) and a packet data network (PDN) GW. The aGW 1101 can also interface with a packet network, such as the Internet 1143.

In an alternative embodiment, as shown in FIG. 11D, the PDCP (Packet Data Convergence Protocol) functionality can reside in the eNB 103 rather than the GW 1101. Other than this PDCP capability, the eNB functions of FIG. 11C are also provided in this architecture.

In the system of FIG. 11D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 1145, which includes a Mobility Anchoring function 1147. According to this architecture, the MME (Mobility Management Entity) 1149 provides SAE (System Architecture Evolution) Bearer Control 1151, Idle State Mobility Handling 1153, and NAS (Non-Access Stratum) Security 1155.

One of ordinary skill in the art would recognize that the processes for acknowledgement signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

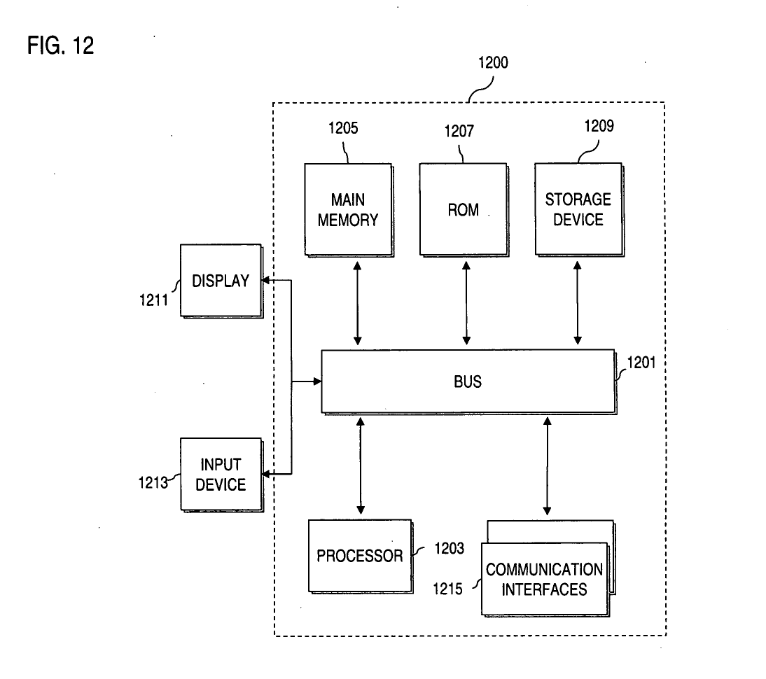

FIG. 12 illustrates exemplary hardware upon which various embodiments of the invention can be implemented. A computing system 1200 includes a bus 1201 or other communication mechanism for communicating information and a processor 1203 coupled to the bus 1201 for processing information. The computing system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computing system 1200 may further include a read only memory (ROM) 1207 or other static storage device coupled to the bus 1201 for storing static information and instructions for the processor 1203. A storage device 1209, such as a magnetic disk or optical disk, is coupled to the bus 1201 for persistently storing information and instructions.

The computing system 1200 may be coupled via the bus 1201 to a display 1211, such as a liquid crystal display, or active matrix display, for displaying information to a user. An input device 1213, such as a keyboard including alphanumeric and other keys, may be coupled to the bus 1201 for communicating information and command selections to the processor 1203. The input device 1213 can include a cursor control, such as a mouse, a trackball, or cursor direction keys, for communicating direction information and command selections to the processor 1203 and for controlling cursor movement on the display 1211.

According to various embodiments of the invention, the processes described herein can be provided by the computing system 1200 in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1200 also includes at least one communication interface 1215 coupled to bus 1201. The communication interface 1215 provides a two-way data communication coupling to a network link (not shown). The communication interface 1215 sends and receives electrical, electromagnetic, or optical signals that carry digital data streams representing various types of information. Further, the communication interface 1215 can include peripheral interface devices, such as a Universal Serial Bus (USB) interface, a PCMCIA (Personal Computer Memory Card International Association) interface, etc.

The processor 1203 may execute the transmitted code while being received and/or store the code in the storage device 1209, or other non-volatile storage for later execution. In this manner, the computing system 1200 may obtain application code in the form of a carrier wave.

The term “computer-readable medium” as used herein refers to any medium that participates in providing instructions to the processor 1203 for execution. Such a medium may take many forms, including but not limited to non-volatile media, volatile media, and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

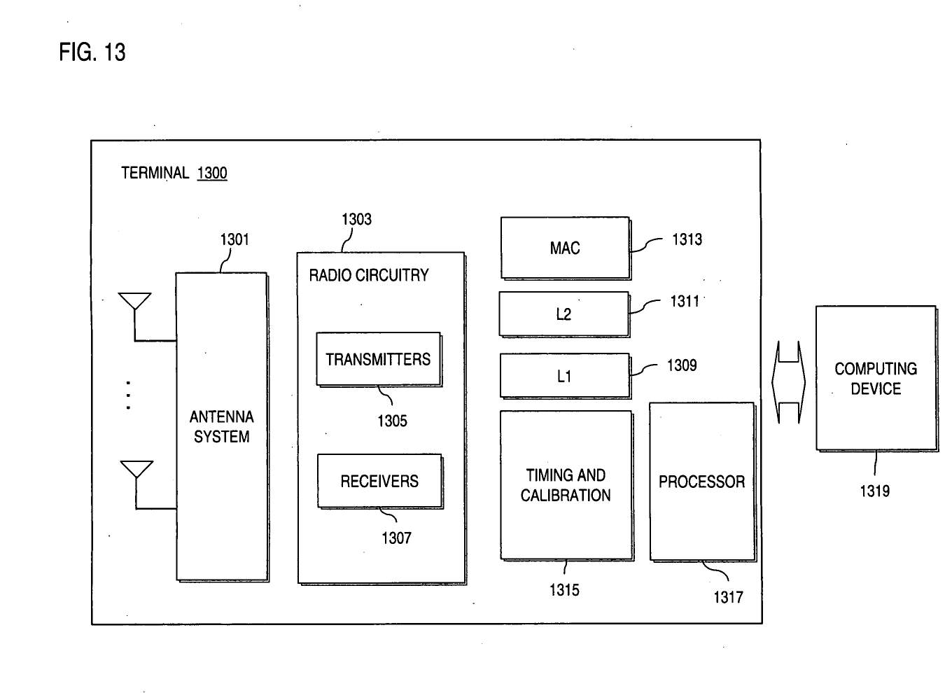

FIG. 13 is a diagram of exemplary components of a user terminal configured to operate in the systems of FIGS. 10 and 11, according to an embodiment of the invention. A user terminal 1300 includes an antenna system 1301 (which can utilize multiple antennas) to receive and transmit signals. The antenna system 1301 is coupled to radio circuitry 1303, which includes multiple transmitters 1305 and receivers 1307. The radio circuitry encompasses all of the Radio Frequency (RF) circuitry as well as base-band processing circuitry. As shown, layer-1 (L1) and layer-2 (L2) processing are provided by units 1309 and 1311, respectively. Optionally, layer-3 functions can be provided (not shown). Module 1313 executes all Medium Access Control (MAC) layer functions. A timing and calibration module 1315 maintains proper timing by interfacing, for example, an external timing reference (not shown). Additionally, a processor 1317 is included. Under this scenario, the user terminal 1300 communicates with a computing device 1319, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
selecting a coding and modulation scheme utilizing a plurality of sub-carriers associated with a common acknowledgement channel serving a plurality of stations; and
mapping a plurality of error control-enabled connections to the common acknowledgement channel by allocating a portion of the sub-carriers to one of the connections and another portion of the sub-carriers to another one of the connections.

2. A method according to claim 1, the method further comprising:
determining channel condition of the common acknowledgement channel, wherein the coding and modulation scheme is selected based on the determination.

3. A method according to claim 1, wherein the sub-carriers include pilot sub-carriers, the method further comprising:
changing pattern of the pilot sub-carriers for a symmetrical distribution among the other sub-carriers.

4. A method according to claim 1, wherein the error control-enabled connections support a hybrid Automatic Repeat Request (ARQ) (HARQ) scheme.

5. A method according to claim 1, wherein the connections correspond to one or more of the stations.

6. A method according to claim 1, wherein the sub-carriers correspond to symbols, the method further comprising:
changing the coding and modulation scheme to another coding and modulation scheme with increased Euclidean distances between the symbols.

7. A method according to claim 1, wherein the acknowledgement channel is established over a radio network compliant with an Institute of Electrical & Electronics Engineers (IEEE) 802.16 protocol suite.

8. A method according to claim 1, wherein the acknowledgement channel is established over an uplink to the radio network.

9. A computer-readable storage medium carrying one or more sequences of one or more instructions which, when executed by one or more processors, cause the one or more processors to perform the method of claim 1.

10. An apparatus comprising:
coding and modulation logic configured to select a coding and modulation scheme utilizing a plurality of sub-carriers associated with a common acknowledgement channel serving a plurality of stations, and to map a plurality of error control-enabled connections to the common acknowledgement channel by allocating a portion of the sub-carriers to one of the connections and another portion of the sub-carriers to another one of the connections.

11. An apparatus according to claim 10, wherein the coding and modulation scheme is selected based on channel condition of the common acknowledgement channel.

12. An apparatus according to claim 10, wherein the sub-carriers include pilot sub-carriers, the coding and modulation logic being further configured to change pattern of the pilot sub-carriers for a symmetrical distribution among the other sub-carriers.

13. An apparatus according to claim 10, wherein the error control-enabled connections support a hybrid Automatic Repeat Request (ARQ) (HARQ) scheme.

14. An apparatus according to claim 10, wherein the connections correspond to one or more of the stations.

15. An apparatus according to claim 10, wherein the sub-carriers correspond to symbols, coding and modulation logic being further configured to change the coding and modulation scheme to another coding and modulation scheme with increased Euclidean distances between the symbols.

16. An apparatus according to claim 10, wherein the acknowledgement channel is established over a radio network compliant with an Institute of Electrical & Electronics Engineers (IEEE) 802.16 protocol suite.

17. An apparatus according to claim 10, wherein the acknowledgement channel is established over an uplink to the radio network.

18. An apparatus according to claim 10, wherein the apparatus is either a base station or a mobile station.

19. A method comprising:
receiving data over a wireless network;
generating an acknowledgement message in response to receipt of the data;
determining channel condition of an acknowledgement channel that is established over the wireless network with one or more stations;
selecting, based on the determined channel condition, a coding and modulation scheme among a plurality of coding and modulation schemes associated with the acknowledgement channel for transmission of the acknowledgement message, wherein the acknowledgement channel includes a plurality of error control-enabled connections corresponding to respective groups of sub-carriers; and
transmitting the acknowledgement message over one of the error control-enabled connections using the selected coding and modulation scheme.

20. A method according to claim 19, wherein the sub-carriers include pilot sub-carriers, the method further comprising:
changing pattern of the pilot sub-carriers for a symmetrical distribution among the other sub-carriers.

21. A method according to claim 19, wherein the sub-carriers correspond to symbols, the method further comprising:
changing the coding and modulation scheme to another coding and modulation scheme with increased Euclidean distances between the symbols.

22. A computer-readable storage medium carrying one or more sequences of one or more instructions which, when executed by one or more processors, cause the one or more processors to perform the method of claim 19.

23. An apparatus comprising:
a transceiver configured to receive data over a wireless network;
error control logic configured to generate an acknowledgement message in response to receipt of the data; and
coding and modulation logic configured to determine channel condition of an acknowledgement channel that is established over the wireless network with one or more stations, and to select, based on the determined channel condition, a coding and modulation scheme among a plurality of coding and modulation schemes associated with the acknowledgement channel for transmission of the acknowledgement message, wherein the acknowledgement channel includes a plurality of error control-enabled connections corresponding to respective groups of sub-carriers,
wherein the transceiver is further configured to transmit the acknowledgement message over one of the error control-enabled connections using the selected coding and modulation scheme.

24. An apparatus according to claim 23, wherein the sub-carriers include pilot sub-carriers, the coding and modulation logic being further configured to change pattern of the pilot sub-carriers for a symmetrical distribution among the other sub-carriers.

25. An apparatus according to claim 23, wherein the sub-carriers correspond to symbols, coding and modulation logic being further configured to change the coding and modulation scheme to another coding and modulation scheme with increased Euclidean distances between the symbols.
